(19) United States
(12) Patent Application Publication
(10) Pub. No.: US 2026/0113598 A1
(43) Pub. Date: Apr. 23, 2026

(54) 5G NETWORK ARCHITECTURE FOR INTEGRATED PROCESSING OF GUARDRAILS APPLIED TO LLM REQUESTS

(71) Applicant: ILIAD, Paris (FR)

(72) Inventors: Khaled Sayad, Paris (FR); Patrick Escande, Paris (FR)

(21) Appl. No.: 19/348,651

(22) Filed: Oct. 2, 2025

(30) Foreign Application Priority Data
Oct. 23, 2024 (EP) 24315493.7
Nov. 27, 2024 (EP) 24315538.9

(51) Int. Cl. H04W 4/12; G06F 40/30

(52) U.S. Cl. CPC H04W 4/12; G06F 40/30

(57) ABSTRACT

This architecture comprises a radio access network, a distributed network of User Plane Functions, UPFs, and a core network control plane comprising 5G functions according to 3GPP. It ensures the processing of requests based on Large Language Models, LLMs, issued by UEs to LLM applications and/or for processing answers sent back in return to LLM requests. The 5G network UPFs are programmed to execute locally LLM rails, acting as LLM input and/or output guardrails as regards the LLM requests and/or the LLM answers, respectively, by: analysis of a content of the LLM requests issued by the UEs towards LLM applications, and/or LLM answers sent back in return by the LLM applications towards the UEs, with respect to a predetermined set of rules; and, as a function of the analysis result, authorization or blocking of transmission, via the UPF, of the LLM request and/or of the LLM answer.

The invention relates to fifth generation (5G) mobile cellular networks, in particular an architecture specifically adapted to processing interactions between user equipments (UEs) and resources associated with Large Language Models (LLMs).

In the present disclosure, the term “users” refers not only to physical persons connected to the 5G network using a smartphone as a UE, but also and above all autonomous hardware devices such as, for example, robots, surveillance cameras or autopiloted vehicles, connected to the 5G cellular network and which profile has already been entered in a user database of the 5G core network.

### STATE OF THE ART

The starting point for the invention is the observation that these various users are liable to send to LLM applications requests that may be produced in very large numbers and at relatively high rates, in particular in the case of autonomous hardware devices.

A LLM application operates by running a pre-trained model to process user tokens (within the meaning of artificial intelligence) and generate the corresponding output. This process may be further optimized using known techniques such as Recovery Augmented Generation (RAG), cache optimisation, LLM routing, etc.

In the case of 5G networks interfaced with LLM applications (AI-oriented 5G networks), these must be optimized to reduce the latency and ensure a high rate, for example to process a very high number of tokens per request.

The invention is particularly aimed at integration and implementation, in such an AI-oriented 5G network, of so-called “guardrails”, hereinafter “rails”, applied to the LLM requests issued by the UEs to LLM applications (“input rails”) and/or in response to the LLM sent in return to the UEs by the LLM applications (“output rails”).

The input rails analyse the requests issued by the UEs to operate a preventive control, for example to prevent inappropriate or irrelevant content from being transmitted to the LLM application: off-topic requests, identifiable personal data (passwords, electronic addresses, etc.), “jailbreaking” attempts when a user tries to bypass the LLM application's protections, etc. If such a situation is detected, the LLM rail will trigger a suitable action, such as blocking transmission of the request to the LLM application, or changing the request, for example by masking or deleting part of the content considered confidential.

The output rails analyse the answers produced by the LLM applications to validate them before transmission to the requesting EU. The anomalies detected liable to lead to an action triggered by the output rail include in particular: “hallucinations” (within the meaning of artificial intelligence), answers that do not comply with predetermined moderation rules, answers with incorrect syntax, etc. The action taken when such situations are detected may be to purely and simply block transmission of the answer to the UE, or to make this answer compliant by filtering and changing the content thereof.

Hereinafter, the invention will mainly be described in response to the input rails, i.e. to the processing of requests issued by the UEs towards LLM applications. However, it should be pointed out that everything explained here may also be transposed, implicitly, to output rails.

Currently, rails are designed by LLM application developers, who integrate them to the logic of their application and ensure the deployment thereof within the framework of the LLM services pipeline proposed to the users.

The design of the LLM rails by the developers has to take into account a number of requirements imposed by the network, in particular in terms of latency, resource usage, overall efficiency, etc.

Furthermore, from the point of view of the network access provider, the transfer to the servers hosting the LLM applications of LLM request packets with inappropriate or invalid content means unnecessary consumption of resources, with negative consequences on the performance of the LLM resources as a result of longer queues, increased request processing times, and increased load on servers hosting the LLM applications.

The low latency is also a particularly critical parameter, in particular when the UEs are purely hardware-based autonomous equipment such as robots, cameras or autopiloted vehicles. Introduction of LLM rails in the LLM implementation process must not have a significantly detrimental impact on the actions produced by this equipment.

Finally, when the LLM requests are associated with tokens that are subject to a charge or a quota (for example, a quota for each department of a company), it is important to limit the use thereof, bearing in mind that any non-compliant request blocked by a LLM rail will have unnecessarily led to consumption of a token.

### DISCLOSURE OF THE INVENTION

The object of the invention is to propose a 5G mobile network architecture for processing LLM requests, which is adapted to efficiently implementing input and/or output LLM rails with: latency minimization, saving on the network resources used, token consumption optimization, overload limitation on the LLM application servers, and, for the developers, flexibility of implementation of LLM rails when designing LLM applications.

The basic idea behind the invention is to take advantage of the distributed architecture and flexibility of 5G networks to dissociate the LLM rails from the LLM applications with which they are associated, and to transfer them to 5G network functions that are located close to the users.

More precisely, the invention proposes to relocate the LLM rails towards user plane functions of the 5G network (User Plane Functions, UPFs, within the meaning of artificial intelligence), this user plane also acting as a data transport plane for routing the data packets to/from the UEs between the UEs and the 5G core network control plane.

Such an architecture, in which the LLM rails are executed locally at the user plane/data plane, close to the users, takes advantage of the availability of the behavioural data of the users, because they are connected to the 5G network and thus directly to the user plane.

This arrangement, by locating the LLM rail execution, which is highly demanding in terms of computing resources and QoS requirements, to 5G network elements close to the users, reduces accordingly the need for remote resources (edge or cloud resources). In other words, blocking non-compliant requests directly at source using LLM rails at UPF level reduces the need to transmit all requests to remote data centres, thus saving bandwidth and reducing energy consumption.

For that purpose, the invention more particularly proposes a mobile network architecture, for processing LLM requests and/or LLM, comprising, in a manner known per se, a 5G network with: a radio access network, for radiofrequency communication with user equipments, UEs; a distributed network of programmable User Plane Functions, UPFs, also acting as a 5G data transport plane for routing data packets towards/from the UEs; and a core network control plane comprising 5G functions according to 3GPP.

Characteristically of the invention, the 5G network UPFs are programmed to execute locally LLM rails, acting as LLM input and/or output guardrails as regards the LLM requests and/or the LLM answers, respectively, by: analysing a content of the LLM requests issued by the UEs towards LLM applications, and/or LLM answers sent back in return by the LLM applications towards the UEs, with respect to a predetermined set of rules; and, as a function of the analysis result, authorizing or blocking the transmission, via the UPF, of the LLM request and/or of the LLM answer.

According to various subsidiary advantageous features:
the LLM rails are stored in a LLM rail register, the LLM rail register is distinct from the 5G network but interfaced with the 5G functions of the 5G network core-network control plane, and the architecture further comprises means to transform the LLM rails of the rail register into programs adapted to be loaded in the programmable UPFs of the 5G network;
in the latter case, the LLM rails are advantageously deployed as Containerized Network Functions, CNFs, on a server storing the LLM rail register;
the predetermined set of rules is stored in a Policy Control Function, PCF, of the 5G network core-network control plane;
the 5G network UPFs are programmed to selectively change the content of the LLM request data based on the result of analysis of the LLM requests issued by the UEs in case of authorization of transmission of the LLM application, in particular by masking a content considered confidential by said analysis;
the 5G network UPFs are programmed to evaluate a metric of LLM application use by the UEs or by a segmented sub-set of UEs, and to dynamically trigger an action when a threshold predetermined by the metric is crossed;
in the latter case, the action is the automatic instantiation of one or more LLM rails when said predetermined threshold is crossed;
moreover, LLM configuration means are provided to, before the LLM requests are processed by a LLM application, pre-register a LLM application identifier in the Network-function Repository Function, NRF, of the 5G network core-network control plane;
moreover, QoS configuration means are provided to, before the LLM requests are processed by a LLM application, pre-register quality of service, QoS, rules specific to the UEs or to segmented sub-sets of UEs, in a Policy Control Function, PCF, of the 5G network core-network control plane;
those QoS rules may comprise in particular rules relating to parameters of: binary rate, latency; bandwidth; maximum number of tokens per second; LLM application server proximity; preservation of the confidentiality of data issued by the UEs; user privileges; and any combination of the above;
the LLM rail register is segmented into a plurality of distinct domains, each domain comprising a group of rails specific to a respective predefined group of UEs, and the 5G network UPFs are programmed to discriminate the UEs based on the domain to which they belong, and to prevent the transmission via the UPF of the LLM requests relating to a domain to which a corresponding requesting UE does not belong;
when the UEs are grouped into distinct domains, the analysis of the content of the LLM requests issued by the UEs to the LLM applications comprises a service discovery function capable of detecting the availability of a particular LLM application to a requesting UE, and the 5G network UPFs are programmed to prevent the transmission via the UPF of the LLM requests for a LLM application relating to a domain to which the requesting UE does not belong;
when privilege levels are assigned to UEs, the 5G network UPFs are programmed to discriminate the UEs based on the privilege level that has been assigned thereto, and to prevent the transmission via the UPF of the LLM requests relating to a privilege level higher than that of the requesting UE, so as to thus operate a control of a Role-Based Access Control, RBAC, type to the LLM applications;
in the previous cases involving domains or privilege levels, the 5G network UPFs are advantageously programmed to discriminate the UEs on the basis of the session IP address assigned to the requesting UE, at the Session Management Function, SMF, of the 5G network core-network control plane;
the 5G network UPFs are programmed to count a number of successive blockages by a UPF against repeated LLM requests from a same UE, and to produce a return message when said number exceeds a predetermined threshold;
the UPFs are programmed in P4 language;
the UEs are devices of the group comprising smartphones, autonomous robots and/or video surveillance cameras, comprising a circuit for connection to the 5G network and which profile has already been entered into a user database of the 5G network core-network.

### BRIEF DESCRIPTION OF THE DRAWINGS

FIG. 1 is an overview, in the form of a block diagram, of the various functional elements of the architecture according to the invention for the processing of LLM rails by a 5G network.

FIG. 2 illustrates, also in the form of a block diagram, the interaction between the different functional elements of FIG. 1, for execution of the LLM rails according to the teachings of the invention.

FIG. 3 is a flow diagram describing the pre-registration of the LLM applications and the QoS rules with the functional elements of the 5G network control plane.

FIG. 4 is a flow diagram describing the integration of the LLM applications and their usage rules with the functional elements of the 5G network control plane and user plane.

FIG. 5 is a flow diagram describing a particular implementation of the invention, aiming at detecting an abnormally high traffic in order to increase, if need be, the control of this traffic by triggering the automatic establishment of LLM rails in response.

FIG. 6 is a flow diagram describing another particular implementation of the invention, aiming at detecting a frequency of use of LLM requests by a UE that exceeds an authorized limit, to trigger the blocking of the offending EU in response.

### DETAILED DESCRIPTION OF EMBODIMENTS OF THE INVENTION

An example of implementation of the invention will now be described with reference to the attached drawings in which the same references designate identical or functionally similar elements throughout the figures.

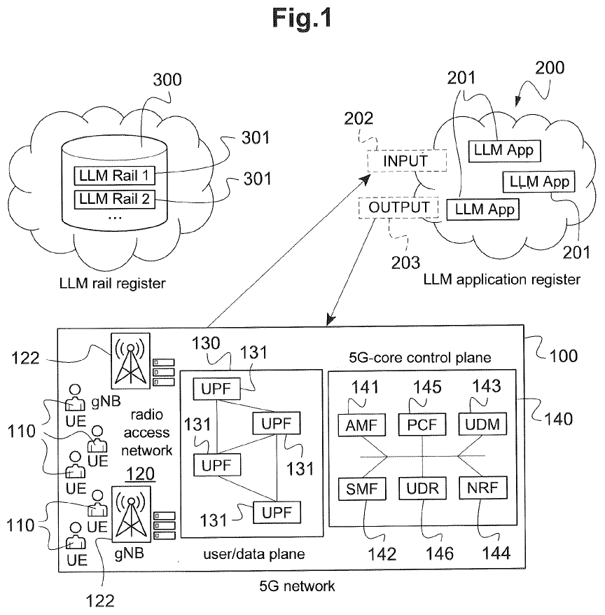

In FIG. 1, reference 100 denotes the main components, known per se, of a 5G network.

References 200 and 300 generally denote hardware resources (servers, datacentres, etc.) used by the 5G network 100 in a delocalized, near or remote way (resources called “far edge”, “edge”, “core cloud”, etc. depending on the case), to maintain therein a LLM application register 201 and a LLM rail register 301, respectively. As regards the LLM rails 301, these are advantageously deployed as Containerized Network Functions, CNFs, on the server 300 storing the LLM rail register.

Said hardware resources are known per se, both in their structure and in the way they are accessed, and are not in themselves changed for the purpose of implementing the invention.

In a conventional configuration—and unlike the present invention—, the LLM rails are integrated to the LLM applications at the LLM application register 200 (at the input as in 202, or at the output as in 203), in the cloud and hence totally externally to the 5G network and remote from this 5G network.

The network 100 is a 5G mobile network, this term being understood in the specific sense as defined by the standardisation bodies, in particular 3GPP. It will be the same for the different components of this 5G network mentioned in the present disclosure, such as “UPF”, “transport plane/data plane”, “control plane”, “AMF”, “SMF”, “UDM”, “NRF”, “PCF”, “UDR”, etc., which must be understood in their specific sense, as understood by a person skilled in the art of mobile communication networks.

Reference 110 denotes user equipments, UEs, used to wirelessly exchange information with the 5G network. As mentioned hereinabove, these users may be both physical persons and purely hardware-based autonomous equipment such as robots, cameras or vehicles, which profile has already been entered into the 5G network.

The 5G network comprises a radio access network part 120 with a number of base stations 122, denoted gNB in the 5G network nomenclature.

The radio access network 120 is interfaced to a distributed network 130 of User Plane Functions, UPFs in the 5G network nomenclature, 131, the user plane also acting as a data transport plane for routing data packets to and from the UEs 110.

It is reminded that, in the 5G networks, the user/data plane is a programmable plane, which makes it possible to configure directly and dynamically the UPFs to locally execute specific tasks linked to the LLM request pipeline management.

Preferably, the UPFs are programmed to meet the following requirements, which may be achieved in particular with a programming language such as the P4 language:
advanced programmability: P4 indeed allows the data plane to be programmed in a flexible, customised way. It is therefore possible to dynamically define and change the way the data packets are processed in the network, which is crucial for meeting the specific requirements of the LLM inferences;
flexibility of the control plane and the data plane: P4 offers a great flexibility for programming not only the data plane 130, but also to interact finely with the control plane 140.

The user plane/data plane 130 is interface to a core network control plane (5G-core), including functions and resources such as:
AMF 141: Access and Mobility-management Function;
SMF 142: Session-Management Function;
UDM 143: User-Data Management;
NRF 144: Network-function Repository Function;
PCF 145: Policy-Control Function;
UDR 146: User-Data Repository, this repository storing in particular the identity and profile of the different known UEs of the network.

Among these functions, NRF, SMF and PCF will be particularly useful in the context of the invention. More precisely:
the NRF function is a function register with which all the 5G function instances register so that they can be discovered (service discovery) by the other 5G functions. The invention further proposes to also register therein the LLM application instances, by mentioning the specific domains served (this notion of “domain”, understood in the sense of a company department, will be developed hereinafter), as well as the corresponding range of the IP addresses of the UEs to be served;
the SMF function (linked with the AMF) is in charge of initiating the PDU sessions of the UEs. It controls the UPFs of the user plane by programming them to establish, for each UE, the routing between the base station in which the UE and the data networks outside the 5G network are located. Within the framework of the invention, it will also be in charge, at the control plane, of creating for each UE connected to the network the link with the LLM applications intended to receive the requests, by further ensuring the associated predefined QoS rules;
the Policy Control Function PCF will further be used, within the framework of the invention, to maintain a set of usage rules applicable to the LLM requests by the LLM rails, as the case may be in a segmented form between distinct domains corresponding to different groups or categories of users.

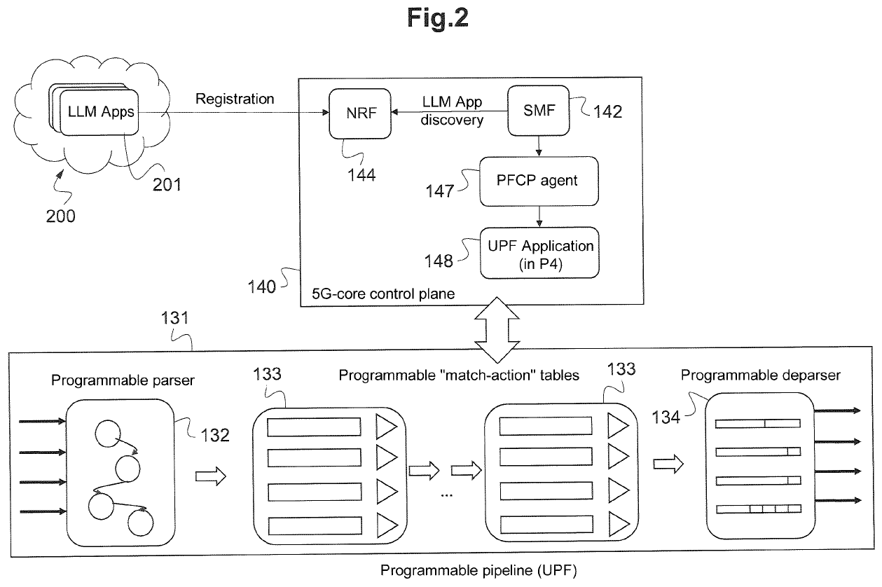

FIG. 2 illustrates the interaction between the different functional elements of FIG. 1, for the execution of the LLM rails according to the teachings of the invention.

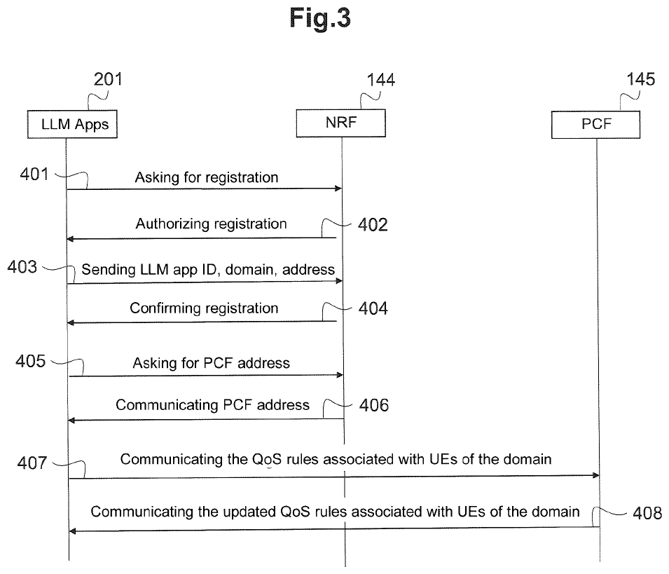

Beforehand, the LLM applications 201 maintained in the remote register 200 register with the NRF 144 of the 5G control plane 140. The detail of this registration will be described with reference to the flow diagram of FIG. 3.

Once the LLM applications registered in the NRF, they will be able to be discovered, at the 5G control plane 140, by the SMF function 142. According to the invention, in addition to its role of initiating the PDU sessions of the UEs, the SMF is charged to deploy the LLM rails on the UPFs. This deployment is performed by transforming the set of rules of the LLM rails into “match-action” instructions (i.e. the detection in a LLM request of a predetermined situation or configuration will trigger a suitable corresponding action). These instructions are transformed into programs, in particular P4 programs, then loaded from the 5G control plane 140, by a PFCP (Packet Forwarding Control Protocol) agent 147 in the UPFs (block 148) of the user plane 130.

These P4 programs are implemented within the UPFs 131 of the user plane 130 in the form of a packet processing pipeline, comprising a programmable parser 132, the match-action tables of the LLM instructions 133 and a programmable de-parser 134.

The parser 132 identifies the headers of the incoming packets of the requests sent by the user, extracts these headers and associates them with variables to be handled by the program. This parser is a state machine which transitions from one state to another are conditional on the headers values: for example, the presence of a certain IP address included or not in certain address ranges, the different ranges corresponding to different domains of the company from which the user LLM requests originate.

The match-action tables 133 analyse the headers issued by the programmable parser 132 and, in case of concordance (“match”) with the predetermined rules loaded in these tables, associate them with predetermined actions (“action”).

The actions triggered may be to purely and simply block transmission of the packets by the UPFs to LLM applications, or to authorize the transmission to the LLM application but with selective modification of the data content of the request, in particular by masking a content considered confidential: the request will then be transmitted to the LLM application, but after the content considered as not being allowed to go beyond the limits of the 5G network has been masked or scrambled.

The match-action tables may also comprise a number of rules corresponding to a segmentation of the set of users liable to be connected to the 5G network into distinct sub-groups, here called “domains”, corresponding for example to different departments of a same company (production, marketing, accounting, etc.) where it is not desired that users of one domain can issue requests relating to another domain of the same company.

The UPFs are then programmed to discriminate the UEs as a function of the domain to which they belong, for example on the basis of the session IP address assigned to the UE by the SMF 142, and to prevent the transmission via the UPF 131 of the LLM requests formulated by a UE of a given domain but which relate to a domain to which this EU does not belong.

As an alternative or complement, the discrimination between the UE may also be performed on the basis of different privilege levels assigned to the UEs. The UPFs are then programmed to prevent the transmission of the LLM requests relating to a privilege level higher than that of the requesting UE. In the context of the invention, LLM requests can therefore be subject to a control of the Role-Based Access Control, RBAC, type allowing only a conditional access to the LLM applications.

Finally, the de-parser 134 ensures the serialization of the modified headers, respecting a specific order, and sends the resulting packet to the following switch of the data plane.

Moreover, the network of the UPFs 131 of the user plane 130 may be segmented into distinct UPFs or distinct groups of UPFs specifically programmed with LLM rails corresponding to a respective domain, the UPFs being then specialized on one or the other of the domains corresponding to respective corresponding groups of users.

FIG. 3 is a flow diagram describing the pre-registration of the LLM applications and the QoS rules with the functional elements of the 5G network control plane.

For that purpose, the LLM application 401, hosted in the cloud at the LLM application register 200 (FIGS. 1 and 2) sends a registering demand to the NRF 144 of the 5G control plane.

As an answer, in 402, the NRF indicates to the LLM application that this registration is authorized, and in return, in 403, the LLM application sends a certain amount of information that allows locating it: identifier, IP address, possibly the related domain, etc.

These identification data are registered in the 5G control plane in the NRF, which confirms the good execution of this registration, in 404.

Thereafter, in 405, the LLM application asks the NRF for the address of the PCF of the 5G control plane, this address being communicated thereto in 406.

In 407, the LLM application transmits to the PCF 145 the QoS rules associated with the UEs of the related domain, describing the way the LLM rails are generated. These QoS rules, which correspond to the “match-action instructions” of FIG. 2, which will be implanted in the UPFs, may in particular comprise rules relating to parameters of:
binary rate;
latency;
bandwidth;
maximum number of tokens per second;
LLM application server proximity;
preservation of the confidentiality of data issued by the UEs;
user privileges;
and any combination of the above.

Finally, in 408, the PCF confirms to the LLM application that these rules have been registered as a policy of management of the LLM rails.

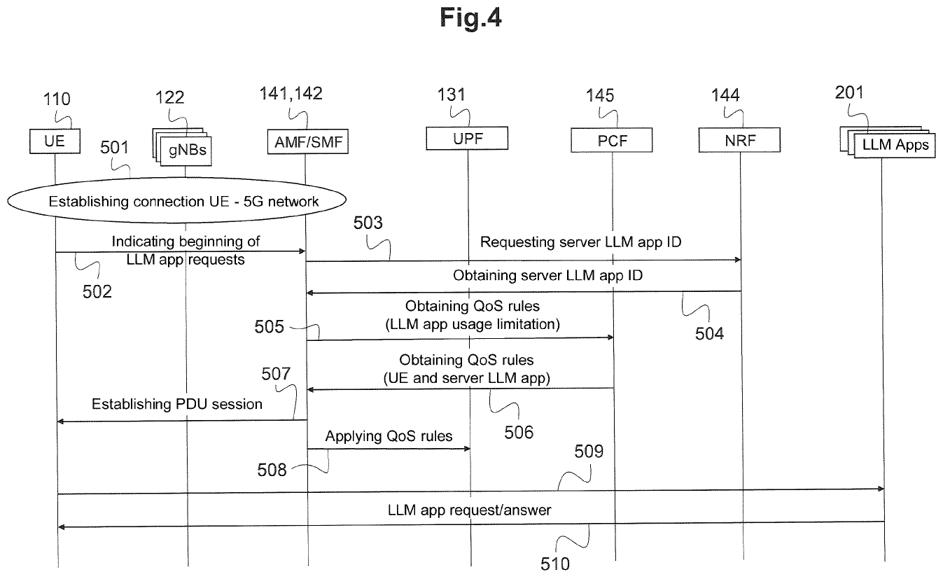

FIG. 4 is a flow diagram describing the integration of the LLM applications and their usage rules (QoS rules) with the functional elements of the 5G network control plane and user plane.

After the UE 110 has established, in 501, a connection to the 5G network by creating a session using AMF/SMF functions 141/142 of the 5G control plane and via the gNB 122, the UE indicates, in 502, to the 5G control plane that it wishes to access one or more LLM applications, by sending corresponding LLM requests.

In 503, the 5G control plane sends by the AMF/SMF to the NRF 144 a request of identification of the server LLM application, corresponding to the LLM request sent to the UE.

The NRF 144, which has stored the LLM application identification parameters acquired in the previous step described hereinabove in FIG. 3, sends back, in 504, the LLM application identification parameters to the AMF/SMF.

In 505, the AMF/SMF asks the PCF to obtain the corresponding QoS rules that, in the same way, have been received and stored at the previous step of FIG. 3.

In 506, these QoS rules are transmitted by the PCF 145 to the AMF/SMF that, having all the necessary information at its disposal, can launch, in 507, the PDU session with the UE 110.

On the other hand, in 508, the AMF/SMF loads in the UPFs 131 of the user plane the QoS rules received from the PCF.

Once this overall configuration established, the LLM request 509/LLM answer 510 exchanges will be possible between the UE 110 and the LLM applications 201 in the cloud. These exchanges are operated by applying at the UPF level of all the QoS rules of the LLM rails, as described with reference to FIG. 2, i.e. with UPF functions which match-action tables will have been programmed according to the LLM rails that are to be introduced into the information exchange between the UE and the LLM applications.

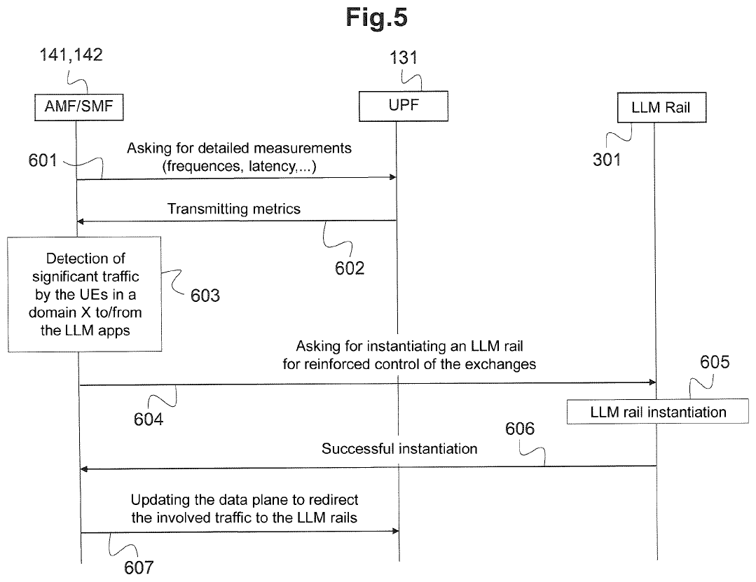

FIG. 5 is a flow diagram describing a particular implementation of the invention, aiming at detecting an abnormally high traffic in order, if need be, to increase the control by establishing LLM rails.

The configuration of the invention indeed makes it possible, depending on certain traffic metrics of the UEs, or UEs in a specific domain, to or from the LLM applications, to automatically trigger an increased control of these exchanges by one or several additional LLM rails dynamically introduced, without interrupting exchanges.

For that purpose, in 601, the 5G control plane interrogates the UPFs 131 of the user plane, via the AMF/SMF, to collect a number of measurements relating to the traffic: frequency of use, latency, etc., these parameters being calculated by the programming (P4 program in the present example) of each UPF.

In 602, these metrics are transmitted by the UPFs to the 5G control plane. If the AMF/SMF detects, in 603, an abnormal traffic, for example a high number of requests/answers in a particular domain to or from certain LLM applications, a request for instantiation of an additional LLM rail is sent, in 604, to the LLM rail register 301. In 605, the reinforced control LLM rail is instantiated at the LLM rail register, this instantiation being confirmed, in 606, to the 5G control plane (AMF/SMF function).

In 607, the 5G control plane thus updates the programming of the data plane UPFs, for example by adding an additional “match-action” table (cf. FIG. 2).

By way of example, it is then possible to monitor and control the use of the LLM resources by the UEs of a given domain in order to limit the use of a quota of tokens allocated to this domain.

As an alternative, in order to reduce the latency of the requests, the additional reinforced control LLM rails may be instantiated at the input or the output of the LLM applications in Virtualized Network Functions, VMFs, as illustrated in 202 and 203 in FIG. 1.

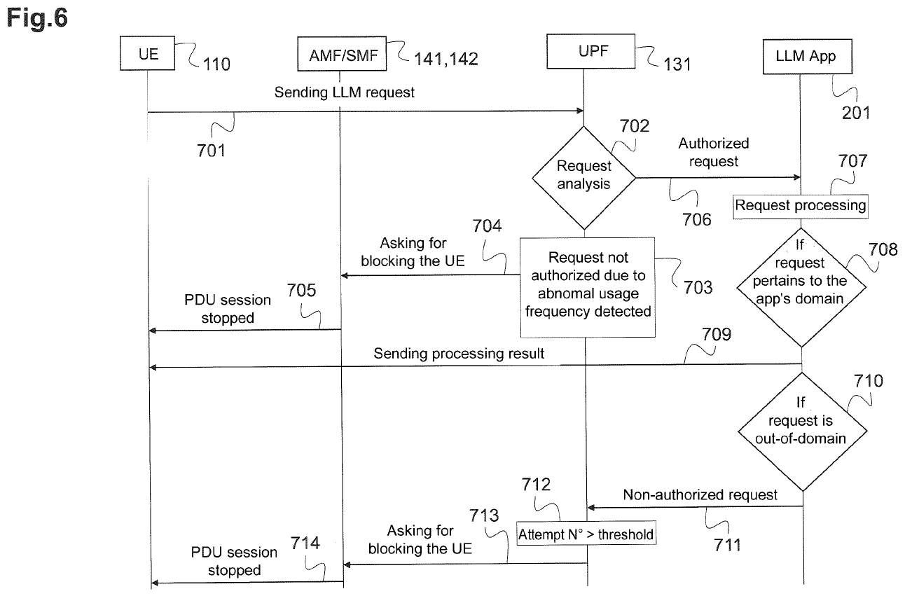

FIG. 6 is a flow diagram describing another particular implementation of the invention, aiming at detecting a frequency of use of LLM resources by a UE that exceeds an authorized limit, to trigger the blocking of the offending EU in response.

When, in 701, the UE 110 sends a request to the UPF, this request is analysed in 702 by the UPF. If considered at this level, in 703, that the frequency of use of the LLM resources by this UE is excessive, then the UPF sends, in 704, to the 5G control plane (AMF/SMF function) a request for blocking the offending UE, leading, in 705, to terminating the current PDU session.

If, at step 702, the request is authorized (no abnormal frequency of use of the LLM resources), the request is sent in 706 to the LLM application 201, that will process it, in 707. The LLM application examines, in 708, if the LLM request pertains or not to the domain of the LLM application, i.e. if the LLM application (for example an application relating to accounting functions) is effectively sent by a UE belonging to the domain in question (the accounting department domain) or not (a UE of another domain: marketing, etc.).

If the request pertains to the application domain, the LLM application sends back to the UE, in 709, the result of the processing performed.

On the other hand, if, in 710, the request is out-of-domain, a corresponding notification is sent, in 711, to the UPF. The UPF then examines if this non-authorized LLM request has already been issued by the UE, and how many times before, in 712. If the number of unsuccessful attempts exceeds a predetermined threshold, then the UPF sends, in 713, to the 5G control plane, a request for blocking the UE (in the same way as in 704, due to an excessive use of the LLM resources), which lead, in 714, to terminating the PDU session by the AMF/SMF of the 5G control plane. The UE will then be blocked because the maximum allowed number of LLM request attempts has been reached.

1. A mobile network architecture, for processing requests based on Large Language Models, LLMs, issued to LLM applications and/or for processing answers sent back, by LLM applications, in return to LLM requests,
in which the architecture comprises a 5G network with:
a radio access network, for radiofrequency communication with user equipments, UEs;
a distributed network of programmable User Plane Functions, UPFs, also acting as a 5G data transport plane for routing data packets towards/from the UEs; and
a core network control plane comprising 5G functions according to 3GPP,
wherein the UPFs of the 5G network are programmed to execute locally LLM rails, acting as LLM input and/or output guardrails as regards the LLM requests and/or the LLM answers, respectively, by:
analysing a content of the LLM requests issued by the UEs towards LLM applications, and/or LLM answers sent back in return by the LLM applications towards the UEs, with respect to a predetermined set of rules; and,
as a function of the analysis result, authorizing or blocking the transmission, via the UPF, of the LLM request and/or of the LLM answer.

2. The processing architecture of claim 1, wherein the LLM rails are stored in a LLM rail register,
wherein the LLM rail register is distinct from the 5G network but interfaced with the 5G functions of the 5G network core-network control plane,
and wherein the architecture further comprises means to transform the LLM rails of the rail register into programs adapted to be loaded in the programmable UPFs of the 5G network.

3. The processing architecture of claim 2, wherein the LLM rails are deployed as Containerized Network Functions, CNFs, on a server storing the LLM rail register.

4. The processing architecture of claim 1, wherein said predetermined set of rules is stored in a Policy Control Function, PCF, of the 5G network core-network control plane.

5. The processing architecture of claim 1, wherein the 5G network UPFs are further programmed to selectively change the content of the LLM request data based on said result of the analysis of the LLM requests issued by the UEs in case of authorization of transmission of the LLM application, in particular by masking a content considered confidential by said analysis.

6. The processing architecture of claim 1, wherein the 5G network UPFs are further programmed to:
evaluate a metric of LLM application use by the UEs or by a segmented sub-set of UEs; and
dynamically trigger an action when a threshold predetermined by the metric is crossed.

7. The processing architecture of claim 6, wherein the action is the automatic instantiation of one or more LLM rails when said predetermined threshold is crossed.

8. The processing architecture of claim 1, further comprising LLM configuration means to, before the LLM requests are processed by a LLM application, pre-register a LLM application identifier in a Network-function Repository Function, NRF, of the 5G network core-network control plane.

9. The processing architecture of claim 1, further comprising QoS configuration means to, before the LLM requests are processed by a LLM application, pre-register quality of service, QoS, rules specific to the UEs or to segmented sub-sets of UEs, in a Policy Control Function, PCF, of the 5G network core-network control plane.

10. The processing architecture of claim 1, wherein the QoS rules comprise rules relating to parameters of:
binary rate;
latency;
bandwidth;
maximum number of tokens per second;
LLM application server proximity;
preservation of the confidentiality of data issued by the UEs;
user privileges;
and any combination of the above.

11. The processing architecture of claim 1, wherein the LLM rail register is segmented into a plurality of distinct domains, each domain comprising a group of rails specific to a respective predefined group of UEs,
and wherein the 5G network UPFs are programmed to discriminate the UEs based on the domain to which they belong, and to prevent the transmission via the UPF of the LLM requests relating to a domain to which a corresponding requesting UE does not belong.

12. The processing architecture of claim 1, wherein the UEs are grouped into distinct domains,
wherein the analysis of the content of the LLM requests issued by the UEs to the LLM applications comprises a service discovery function capable of detecting the availability of a particular LLM application to a requesting UE,
and wherein the 5G network UPFs are programmed to prevent the transmission via the UPF of the LLM requests for a LLM application relating to a domain to which the requesting UE does not belong.

13. The processing architecture of claim 1, wherein privilege levels are assigned to UEs,
and wherein the 5G network UPFs are programmed to discriminate the UEs based on the privilege level that has assigned thereto, and to prevent the transmission via the UPF of the LLM requests relating to a privilege level higher than that of the requesting UE,
so as to thus operate a control of a Role-Based Access Control, RBAC, type to the LLM applications.

14. The processing architecture of claim 11 wherein the 5G network UPFs are programmed to discriminate the UEs (110) on the basis of the session IP address assigned to the requesting UE, at the Session Management Function, SMF, of the 5G network core-network control plane.

15. The processing architecture of claim 1, wherein the 5G network UPFs are further programmed to count a number of successive blockages by a UPF against repeated LLM requests from a same UE, and to produce a return message when said number exceeds a predetermined threshold.

16. The processing architecture of claim 1, wherein the UPFs are programmed in P4 language.

17. The processing architecture of claim 1, wherein the UEs are devices of the group comprising smartphones, autonomous robots and/or video surveillance cameras, comprising a circuit for connection to the 5G network and which profile has already been entered into a 5G core network user database.

18. The processing architecture of claim 12 wherein the 5G network UPFs are programmed to discriminate the UEs (110) on the basis of the session IP address assigned to the requesting UE, at the Session Management Function, SMF, of the 5G network core-network control plane.

19. The processing architecture of claim 13 wherein the 5G network UPFs are programmed to discriminate the UEs (110) on the basis of the session IP address assigned to the requesting UE, at the Session Management Function, SMF, of the 5G network core-network control plane.
